(19) United States
(12) Patent Application Publication
(10) Pub. No.: US 2021/0007346 A1
(43) Pub. Date: Jan. 14, 2021

(54) SCENT DISPERSAL APPARATUS AND METHOD

(71) Applicants: Brett A. Andrews, Sugar Land, TX (US); Gary Andrews, Richmond, TX (US)

(72) Inventors: Brett A. Andrews, Sugar Land, TX (US); Gary Andrews, Richmond, TX (US)

(21) Appl. No.: 16/924,854

(22) Filed: Jul. 9, 2020

Related U.S. Application Data
(60) Provisional application No. 62/921,831, filed on Jul. 9, 2019.

(51) Int. Cl. A01M 31/00; A01M 29/12

(52) U.S. Cl. CPC A01M 31/008; A01M 29/12

(57) ABSTRACT

Apparatus for dispersing a hunting scent into the air adjacent a hunting location. The apparatus includes: (a) a perforated housing; (b) a container of hunting scent infused into wood and/or wood fibers; and (c) a battery powered fan, the container of hunting scent and the battery powered fan positioned within the perforated housing so that air is flowed by the fan into the perforated housing, onto the hunting scent and out of the perforated housing to disperse the hunting scent into the air adjacent a hunting location. In addition, a method for dispersing a hunting scent into the air adjacent a hunting location. The method includes the steps of flowing air onto a hunting scent and then into the air adjacent a hunting location.

### CROSS-REFERENCE TO RELATED APPLICATION

This application claims the benefit of U.S. Provisional Application No. 62/921,831, filed Jul. 9, 2019, and which is hereby incorporated by reference in its entirety.

### TECHNICAL FIELD

This disclosure relates to systems for the dispersion of a scent by a hunter.

### BACKGROUND

Hunting wild game such as, and without limitation to, deer, antelope, elk, moose, coyote, bobcat, blacktail deer, mule deer, wild hogs, javilena and bear, is a sport enjoyed by millions of men and women across the country. Attracting said game with a scent is well known. Different types of scents have been used for many years with mixed results. In recent years, more successful scents or lures have been developed. For example, scents derived from deer urine are frequently used by deer hunters. Different scents are attractive to bucks and does, and the particular scent chosen by a hunter will be determined by the type of game the hunter is trying to attract.

A number of advancements have been made in the art of scent dispersion systems. For example, U.S. Pat. No. 6,443,434 discloses a forced air dispenser for scents used to attract animals, the system comprising a housing having an air intake at one end and an air outlet at the other end. Inside the housing of the '434 system are a battery, a timer circuit, a fan, and a container for liquid scent. Evaporation of the liquid scent is enabled by heating the liquid. Scent vapor is mixed with air as the air is forced through the housing by the fan; the scent-laden air is blown out into the surroundings via the outlet. A problem with systems exemplified by the '434 patent is the tendency of the liquid scent to be spilled and the need to heat the liquid scent. It would be an advance in the art of systems for hunting scent dispersion if a system were discovered that solved the problem of spilling liquid scent and which did not require heating a liquid scent. Spilled liquid scent can cause cross-contamination and can even be a health hazard for the hunter and/or wildlife.

### SUMMARY

A scent dispersal apparatus includes a housing defining a compartment and a plurality of apertures. Hunting scent infused into wood and/or wood fibers is within the compartment. A battery powered fan is positioned within the housing so that, when the fan is in operation, the fan causes air to flow onto the hunting scent and out of the apertures to disperse the hunting scent into the air adjacent a hunting location.

A method for dispersing a hunting scent into the air adjacent a hunting location includes causing air to flow onto a hunting scent infused into wood and/or wood fibers and then into the air adjacent the hunting location.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, front view of a scent dispersal apparatus including a housing and a container of hunting scent infused into wood and/or wood fibers;

FIG. 2 is a schematic, perspective view of the container of hunting scent; and

FIG. 3 is a schematic, top view of alternative lids usable with the container of FIGS. 1 and 2.

### DESCRIPTION OF THE PREFERRED EMBODIMENTS

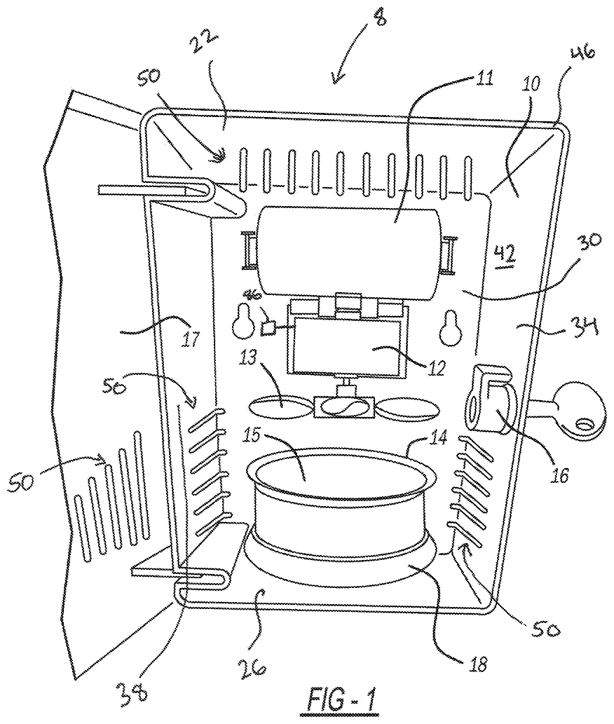

Referring now to FIG. 1, therein is shown a photograph of a scent dispersal apparatus 8. The apparatus 8 shown in FIG. 1 comprises perforated housing 10 having hinged door 17 and door latch 16. Container 14 contains hunting scent 15 infused into wood and/or wood fibers. A battery powered fan comprising battery 11, electric motor 12 and fan 13 is positioned within housing 10. When the battery powered fan 13 is switched on, air is flowed by fan 13 into the perforated housing 10, onto the hunting scent 15 and out of the perforated housing 10 to disperse the hunting scent into the air adjacent a hunting location. The apparatus 8 includes a stand 18 for centering the container 14 directly below the fan 13.

More specifically, in the embodiment depicted the housing 10 is substantially in the shape of a hollow rectangular cuboid, with a top wall 22, a bottom wall 26, a rear wall 30, and two side walls 34, 38. The walls 22, 26, 30, 34, 38 cooperate to define a compartment 42 that contains the fan 13, battery 11, motor 12, and container 14. The housing 10 defines an opening 46 to the compartment 42 so that a user can insert and remove containers 14 with scent 15 as desired. The door 17 obstructs and covers the opening 46 when the door 17 is in a closed position. The walls 22, 30, 34, 38 and the door 17 define perforations or apertures 50. In the embodiment depicted, the apertures 50 are elongated as shown.

The specific hunting scent used is not critical in the instant invention and for deer hunting can include, for example and without limitation thereto, doe in heat, doe in estrous, buck urine, and buck tarsal gland scents. Other scents such as tarsal, preorbital, interdigital, vaginal, and/or anal gland extracts may be employed within the scope of the claimed invention. For bear hunting the scent used can include, for example and without limitation thereto, crushed berries, molasses, honey, and bacon scents. For wild hog hunting the scent used can include, for example and without limitation thereto, crushed berries and molasses, apple and sweet corn, sour corn and strawberries, sour buttermilk and peanut butter as well as sow in heat. Without limitation thereto, cedar, pine, acorn, natural earth forage, vanilla, luscious red apple, and skunk can all be used in the instant invention to cover the hunters scent.

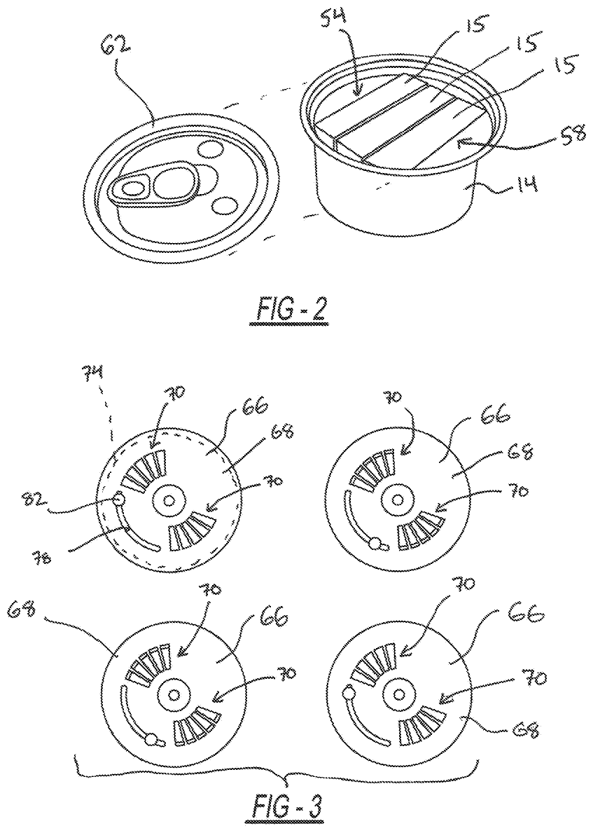

In the embodiment depicted, the container 14 is a two ounce cylindrical can. Referring specifically to FIG. 2, wherein like reference numbers refer to like components from FIG. 1, the container 14 defines a cylindrical interior space 54 containing a hunting and or trapping scent 15 infused into pieces 58 of wood and/or wood fiber. In the embodiment depicted, pieces 58 are formed of wood fibers compressed into rectangular blocks. The container 14 may include a lid 62 to retain the pieces 58; a user will remove the lid 62 prior to placing the container 14 with the pieces 58 infused with scent 15 into the compartment 42 on stand 18. The lid 62 may be a zip-off lid as shown in FIG. 2.

Referring to FIG. 3, alternative lids 66 that may be employed with the container 14 are schematically depicted. Lids 66 can be colored to correspond to a specific scent and can comprise variable shutters as shown in FIG. 3. More specifically, each lid 66 include a first piece 68 defining a plurality of radially-extending slots. Each lid further includes a second piece, only one of which is shown in phantom at 74. The second piece 74 is rotatably connected to the first piece 68. The second piece 74 defines a plurality of holes (not shown). The second piece 74 also includes a pin portion 82 that extends through an arcuate slot 78 formed in the first piece 68. A user can rotate the second piece 74 relative to the first piece 78 by moving the pin portion 82 in the slot 78.

The second piece 74 is rotatable between a first position in which none of the holes defined by the second piece are aligned with the slots 70 in the first piece 68, and a second position in which the holes in the second piece 74 are aligned with the slots 70 in the first piece 68. Thus, a user can control the exposure of the pieces 58 contained in the container 14 by manipulating the pin portion 82.

Referring again to FIG. 1, the battery powered fan of the instant invention can be operated by a control system 86, which may, for example, be a programmable timer and/or remote control. When used, a remote controller could be sold with the system or as a separate item. Operation of the fan of the instant invention by a programmed timer and/or by remote control limits the exposure of the hunter and the hunters scent on the trail to the location of the apparatus of the instant invention. Operation of the fan of the instant invention by remote control can be an effective means of drawing distantly observed game closer to the hunter. The instant invention can be placed on or off the ground.

A method of using the apparatus 8 includes obtaining a container 14 containing pieces 58 of wood and/or wood fibers infused with a hunting or trapping scent 15. The method may also include removing the lid 62, or manipulating the pin portion 82, to expose the pieces 58 of wood and/or wood fibers infused with a hunting or trapping scent 15. The method then includes placing the container with the exposed pieces 58 of wood and/or wood fibers infused with a hunting or trapping scent 15 in the compartment 42 and/or on the stand 18. Stand 18 may define a concavity slightly larger than the diameter of the container 14 to assist in placing and retaining the container 14.

The method may then include moving the door 17 to its closed position and causing the fan 13 to blow air on or across the pieces 58 of wood and/or wood fibers infused with a hunting or trapping scent 15, thereby causing some of the scent 15 to mix with the air and exit the compartment via the apertures 50.

While the best modes for carrying out the invention have been described in detail, those familiar with the art to which this invention relates will recognize various alternative designs and embodiments for practicing the invention within the scope of the appended claims.

1. An apparatus for dispersing a hunting scent into the air adjacent a hunting location, comprising:
a perforated housing;
hunting scent infused into wood and/or wood fibers within the housing; and
a fan positioned within the perforated housing to cause air to flow onto the hunting scent and out of the perforated housing to disperse the hunting scent into the air adjacent a hunting location.

2. The apparatus of claim 1, further comprising a programmable timer operatively connected to the fan and configured to control the operation of the fan.

3. The apparatus of claim 1, further comprising a remote controller operatively connected to the fan and configured to control the operation of the fan.

4. The apparatus of claim 1, further comprising a cylindrical container containing the hunting scent infused into wood and/or wood fibers.

5. The apparatus of claim 4, wherein the cylindrical container includes a lid having variable shutters.

6. A method for dispersing a hunting scent into the air adjacent a hunting location, comprising: causing air to flow onto a hunting scent infused in wood and/or wood fibers and then into the air adjacent a hunting location.

7. The method of claim 6, further comprising programming the time of the flowing of the air onto the hunting scent.

8. The method of claim 6, further comprising remotely controlling the flow of air onto the hunting scent.

9. An apparatus comprising:
a container defining an interior space; and
a solid material in the interior space; and
hunting scent infused in the solid material.

10. The apparatus of claim 9, wherein said container is a cylindrical can.

11. The apparatus of claim 10, wherein said solid material is wood or wood fibers.

12. The apparatus of claim 11, wherein said solid material is wood fibers pressed together to form blocks.

13. The apparatus of claim 9, wherein the cylindrical can includes a removable lid.

14. The apparatus of claim 9, wherein the cylindrical can includes a lid having variable shutters.
